(19) United States
(12) Patent Application Publication
(10) Pub. No.: US 2025/0022014 A1
(43) Pub. Date: Jan. 16, 2025

(54) Automated and Dynamic Provisioning of Synchronized Product-Related Prompts Within Media Content

(71) Applicant: Disney Enterprises, Inc., Burbank, CA (US)

(72) Inventor: Keith Comito, Seaford, NY (US)

(21) Appl. No.: 18/219,931

(22) Filed: Jul. 10, 2023

(51) Int. Cl. G06Q 30/0241; G06Q 30/0201

(52) U.S. Cl. CPC G06Q 30/0277; G06Q 30/0201

(57) ABSTRACT

A system includes a processor, an input unit; and a memory storing software code. The processor executes the software code to receive an activation input from a user, and generate, using the input unit, media content including a performance by the user or a performer. The processor further executes the software code to identify, while generating the media content, a product referenced by the user or performer, dynamically obtain up-to-date marketing data for the product, generate metadata for use in providing one or more product-related prompts synchronized with one or references to the product made by one of the user or the performer during the performance, and output the media content accompanied by the metadata. The one or more product-related prompts enable a consumer of the media content to trigger an interaction associated with the product while consuming the media content.

### BACKGROUND

The marketing and sales of products through live-streamed and video on demand (VOD) media have become increasingly popular. For example, the growth of live-stream shopping in China has accelerated substantially in recent years, and is now a market worth hundreds of billions of dollars.

Companies such as TikTok®, Amazon®, and YouTube®, all now offer limited ways for content creators to promote and sell products on their respective platforms. However, all current methods for enabling such media-based product selling require cumbersome manual set up processes. For instance, conventional media-based product selling solutions typically require content creators to manually enter or link metadata for products to be sold on a forthcoming content stream, and are static in nature, i.e., they are unable to accommodate dynamic situations such as a content creator making a real-time decision to showcase a different product. Moreover, because they require manual input or identification of product related metadata, and manual association of the product metadata with metadata of the media content being viewed, conventional solutions for enabling media-based product selling are undesirably time consuming and error prone. Thus, there is a need in the art for an automated solution for automatically and dynamically producing synchronized product-related prompts that may be presented to viewers of or listeners to media content along with that media content.

### BRIEF DESCRIPTION OF THE DRAWINGS

FIG. 1 shows an exemplary system for performing automated and dynamic provisioning of synchronized product-related prompts within media content, according to one implementation;

FIG. 2 shows a more detailed diagram of an input unit suitable for use as a component of the system shown in FIG. 1, according to one implementation;

FIG. 3 shows a more detailed diagram of an exemplary connected product for use in generating a product-related prompt to accompany media content, according to one implementation;

FIG. 4 shows a more detailed diagram of an output unit suitable for use as a component of the connected product in FIG. 3, according to one implementation; and

FIG. 5 shows a flowchart presenting an exemplary method for use by a system to perform automated and dynamic provisioning of synchronized product-related prompts within media content, according to one implementation.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

The present application discloses systems and methods for performing automated and dynamic provisioning of synchronized product-related prompts within media content that address and overcome the deficiencies in the conventional art, and enable a consumer of that media content, such as a viewer of or listener to the media content, to trigger an interaction associated with one or more products while consuming the media content. The solution disclosed by the present application allows products that are shown, discussed, or otherwise referenced in media content to be automatically identified and have their positions relative to a performer located during a live-stream, broadcast, or video on demand (VOD) recording session, relevant product metadata to be automatically obtained, and media-synchronized product purchase prompts to automatically be presented to viewers of the live-stream, broadcast, or VOD content.

Specifically, the solution disclosed in the present application implements a metadata fetching paradigm that enables the automated acquisition of real-time product identification and up-to-date marketing data regarding physical products such as toys, Internet of things (IOT) devices, or intangible products such as augmented reality (AR) objects, artificial intelligence (AI) characters, or digital assets, including those related to non-fungible tokens (NFTs), by a system utilized by a content creator (hereinafter “user”) to provide a media content accompanied by synchronized product-related prompts. The present solution further enables consumers of the media content to trigger an interaction associated with a product by responding to the product-related prompt. Examples of such triggered interactions may include learning more about the product, purchasing the product, and sharing the product with another user, to name a few.

It is noted that, as defined in the present application, the expression “consumer” refers to a human consumer of media content in the form of video images unaccompanied by audio, audio-video (AV) content including both video images and audio, or audio unaccompanied by video. Thus, a “consumer” of video unaccompanied by audio is a viewer of that video, a “consumer” of AV content is a viewer of and/or a listener to that AV content, while a “consumer” of audio unaccompanied by video is a listener to that audio.

It is further noted that the media content accompanied by one or more product-related prompts provided according to the present novel and inventive concepts may be or include digital representations of persons, fictional characters, locations, objects, and identifiers such as brands and logos, for example, which populate a virtual reality (VR). AR, or mixed reality (MR) environment. Moreover, that media content may depict virtual worlds that can be experienced by any number of users synchronously and persistently, while providing continuity of data such as personal identity, user history, entitlements, possessions, payments, and the like. It is noted that such media content may also include content that is a hybrid of traditional AV and fully immersive VR/AR/MR experiences, such as interactive video.

It is further noted that as defined in the present application, the terms “automation,” “automated,” and “automating” refer to systems and processes that do not require the participation of a human administrator. Although in some implementations the media content accompanied by one or more product-related prompts provided by the systems and methods disclosed herein may be reviewed or even modified by a human content creator, that human involvement is optional. Thus, the methods described in the present application may be performed under the control of hardware processing components of the disclosed systems.

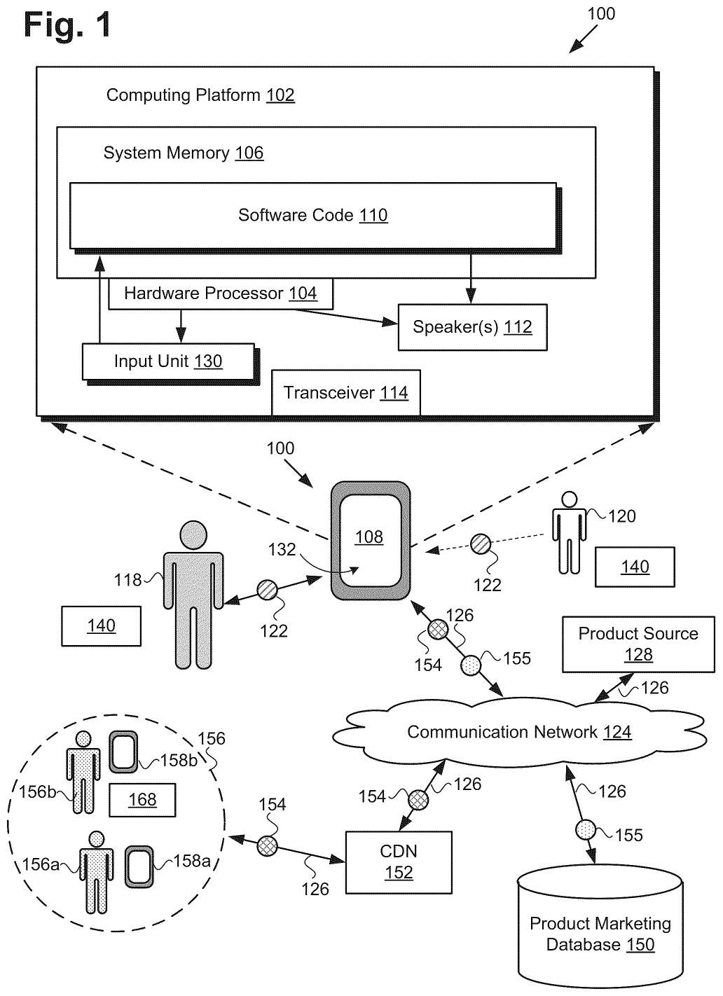

FIG. 1 shows a diagram of system 100 for performing automated and dynamic provisioning of synchronized product-related prompts within media content, according to one exemplary implementation. As shown in FIG. 1, system 100 includes computing platform 102 having hardware processor 104, input unit 130 including input device 132 in the form of a touchscreen, display 108, one or more speakers 112 (hereinafter “speaker(s) 112”), transceiver 114, and system memory 106 implemented as a non-transitory storage medium. According to the present exemplary implementation, system memory 106 stores software code 110. In addition, FIG. 1 shows user 118 of system 100, optional performer 120, and product 140, which may be shown, discussed, or otherwise referenced, by one or both of user 118 or performer 120.

According to the exemplary implementation shown in FIG. 1, system 100 is utilized in a use environment including communication network 124, source 128 of product 140 (hereinafter “product source 128”), product marketing database 150, and content delivery network (CDN) 152. In addition, FIG. 1 shows media content 122 including a performance by one of user 118 or performer 120, up-to-date marketing data 155 for product 140, and media content 154 accompanied by metadata for use in providing one or more product-related prompts (hereinafter “media content with prompt(s) metadata 154”) provided by system 100 in an automated process using media content 122 and up-to-date marketing data 155. Also shown in FIG. 1 are network communication links 126 of communication network 124, and one or more consumers 156 of media content with prompt(s) metadata 154, including consumer 156a utilizing user device 158a, and consumer 156b utilizing user device 158b and in possession of another product 168 (hereinafter “possessed product 168”).

It is noted that product 140 may be a physical commodity, i.e., a good, a service, a financial instrument such as a stock, bond, or insurance policy for example, or a digital asset such as software or an NFT for instance. It is further noted that although FIG. 1 depicts one optional performer 120 and two consumers 156a and 156b of media content with prompt(s) metadata 154, that representation is merely exemplary. In other implementations, user 118 may show, discuss, or otherwise reference product 140 rather than performer 120, or multiple performers corresponding to performer 120 may show, discuss, or otherwise reference product 140. That is to say, in various implementations performer 120 may not participate in showing, discussing, or otherwise referencing product 140 in media content with prompt(s) metadata 154, or more than one performer 120 may show, discuss, or otherwise reference product 140 in media content with prompt(s) metadata 154. Moreover, one or more consumers 156 of media content with prompt(s) metadata 154 may include as few as one viewer of media content with prompt(s) metadata 154, or tens, hundreds, thousands, or millions of viewers of media content with prompt(s) metadata 154.

Although the present application refers to software code 110 as being stored in system memory 106 for conceptual clarity, more generally, system memory 106 may take the form of any computer-readable non-transitory storage medium. The expression “computer-readable non-transitory storage medium,” as defined in the present application, refers to any medium, excluding a carrier wave or other transitory signal that provides instructions to hardware processor 104 of computing platform 102. Thus, a computer-readable non-transitory medium may correspond to various types of media, such as volatile media and non-volatile media, for example. Volatile media may include dynamic memory, such as dynamic random access memory (dynamic RAM), while non-volatile memory may include optical, magnetic, or electrostatic storage devices. Common forms of computer-readable non-transitory storage media include, for example, optical discs. RAM, programmable read-only memory (PROM), erasable PROM (EPROM), and FLASH memory.

Moreover, in some implementations, system 100 may utilize a decentralized secure digital ledger in addition to, or in place of, system memory 106. Examples of such decentralized secure digital ledgers may include Blockchain, Hashgraph, Directed Acyclic Graph (DAG), and Holochain ledgers, to name a few. In use cases in which the decentralized secure digital ledger is a blockchain ledger, it may be advantageous or desirable for the decentralized secure digital ledger to utilize a consensus mechanism having a proof-of-stake (PoS) protocol, rather than the more energy intensive proof-of-work (PoW) protocol.

Hardware processor 104 may include multiple hardware processing units, such as one or more central processing units, one or more graphics processing units, and one or more tensor processing units, one or more field-programmable gate arrays (FPGAs), and an application programming interface (API) server, for example. By way of definition, as used in the present application, the terms “central processing unit” (CPU). “graphics processing unit” (GPU), and “tensor processing unit” (TPU) have their customary meaning in the art. That is to say, a CPU includes an Arithmetic Logic Unit (ALU) for carrying out the arithmetic and logical operations of computing platform 102, as well as a Control Unit (CU) for retrieving programs, such as product promotion software code 110, from system memory 106, while a GPU may be implemented to reduce the processing overhead of the CPU by performing computationally intensive graphics or other processing tasks. A TPU is an application-specific integrated circuit (ASIC) configured specifically for AI applications such as machine learning modeling.

Although system 100 is depicted as a smartphone or tablet computer of user 118 in FIG. 1, that representation is provided merely by way of example. In other implementations, system 100 may take the form of any suitable mobile or stationary computing device or system that implements data processing capabilities sufficient to support connections to communication network 124 and implement the functionality ascribed to system 100 herein. That is to say, in various implementations, system 100 may take the form of a television (TV) or movie camera, a desktop computer, a laptop computer, or a wearable communication device such as a head-mounted or other type of body camera, to name a few examples.

With respect to display 108, it is noted that displays 108 may take the form of a liquid crystal display (LCD), light-emitting diode (LED) display, organic light-emitting diode (OLED) display, quantum dot (QD) display, or any other suitable display screen that perform a physical transformation of signals to light. In various implementations, display 108 may be physically integrated with system 100 or may be communicatively coupled to but physically separate from respective system 100. For example, where system 100 is implemented as a smartphone, laptop computer, or tablet computer, display 108 will typically be integrated with system 100. By contrast, where system 100 is implemented as a desktop computer, display 108 may take the form of a monitor separate from system 100 in the form of a computer tower. Moreover, it is noted that in some use cases, system 100 may omit a display, such as when system 100 takes the form of a head mounted or other type of body camera, for example, or in any other use case in which omission of display 108 is appropriate or acceptable.

Input device 132 of system 100 may include any hardware and software enabling 118 to enter data into system 100. In various implementations of system 100, examples of input device 132 may include a keyboard, trackpad, joystick, touchscreen, or voice command receiver, to name a few. Transceiver 114 of system 100 may be implemented as any suitable wireless communication unit. For example, transceiver 114 may include a fourth generation (4G) wireless transceiver and/or a 5G wireless transceiver. In addition, or alternatively, transceiver 114 may be configured for communications using one or more of Wireless Fidelity (Wi-Fi®), Worldwide Interoperability for Microwave Access (WiMAX®), Bluetooth®. Bluetooth® low energy (BLE), ZigBee®, radio-frequency identification (RFID), near-field communication (NFC), and 60 GHz wireless communications methods. Moreover, it is noted that in various implementations, transceiver 114 may include as few as a single antenna for each supported communication mode, or may include an array of multiple antennas for one or more supported communication modes.

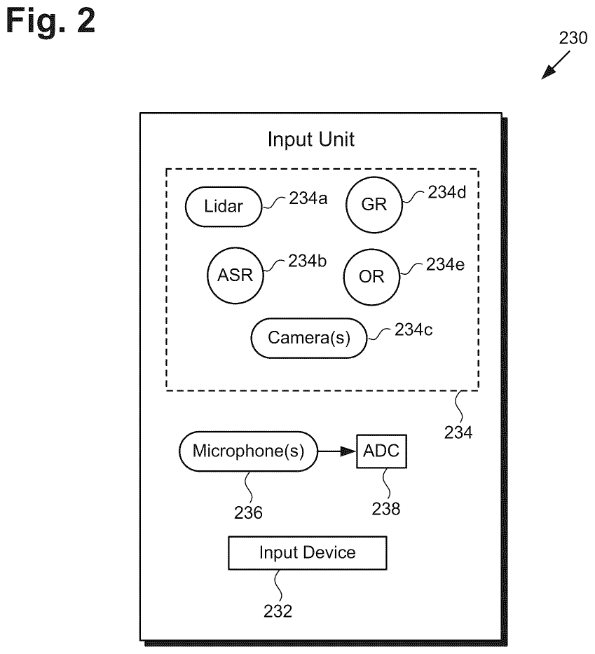

FIG. 2 shows a more detailed diagram of input unit 230 suitable for use as a component of system 100, in FIG. 1, according to one implementation. As shown in FIG. 2, input unit 230 may include input device 232, multiple sensors 234, one or more microphones 236 (hereinafter “microphone(s) 236”), and analog-to-digital converter (ADC) 238. As further shown in FIG. 2, sensors 234 of input unit 230 may include one or more of laser imaging, detection, and ranging (lidar) detector 234a, automatic speech recognition (ASR) sensor 234b, one or more cameras 234c (hereinafter “camera(s) 234c”), gesture recognition (GR) sensor 234d, and object recognition (OR) sensor 234e. Input unit 230 and input device 232 correspond respectively in general to input unit 130 and input device 132, in FIG. 1. Thus, input unit 130 and input device 132 may share any of the characteristics attributed to respective input unit 230 and input device 232 by the present disclosure, and vice versa.

It is noted that the specific sensors shown to be included among sensors 234 of input unit 130/230 are merely exemplary, and in other implementations, sensors 234 of input unit 130/230 may include more, or fewer, sensors than lidar detector 234a, ASR sensor 234b, camera(s) 234c, GR sensor 234d, and OR sensor 234e. Moreover, in some implementations, sensors 234 may include a sensor or sensors other than one or more of lidar detector 234a, ASR sensor 234b, camera(s) 234c. GR sensor 234d, and OR sensor 234e. It is further noted that, when included among sensors 234 of input unit 130/230, camera(s) 234c may include various types of cameras, such as red-green-blue (RGB) still image and video cameras. RGB-D cameras including a depth sensor, and infrared (IR) cameras, for example.

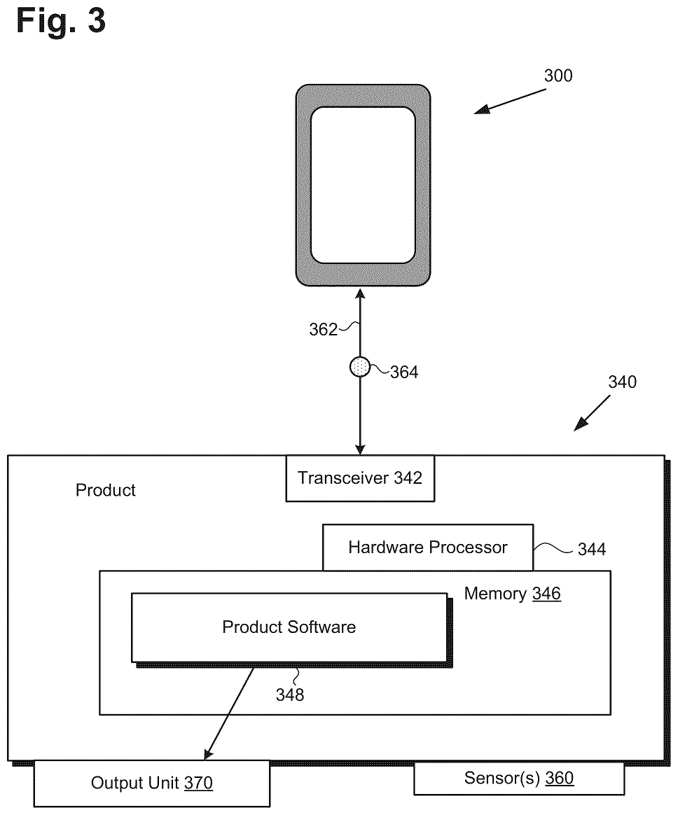

FIG. 3 shows a more detailed diagram of an exemplary connected product 340 for use in generating a product-related prompt to accompany media content, according to one implementation. As shown in FIG. 3, in some implementations product 340 may be a smart device including transceiver 342, hardware processor 344, one or more sensors 360 (hereinafter “sensor(s) 360”), output unit 370, and memory 346 implemented as a non-transitory storage medium storing product software 348. Also shown in FIG. 3 are system 300 in communication with product 340 wireless communication link 362, and communication signal 364 received by system 300 from product 340. It is noted that in various implementations wireless communication line 362 may be unidirectional or bidirectional. It is further noted that, although not depicted in FIG. 3, in some implementations, product 340 may include articulable limbs, as well as motor controlled tracks or wheels enabling locomotion by product 340.

It is noted that system 300 and product 340, in FIG. 3, correspond respectively in general to system 100 and product 140, in FIG. 1. Thus, system 300 and product 340 may share any of the characteristics attributed to respective system 100 and product 140 by the present disclosure, and vice versa. That is to say, although not shown in FIG. 1, product 140 may include features corresponding respectively to transceiver 342, hardware processor 344, sensor(s) 360, output unit 370, and memory 346 storing product software 348. Furthermore, in various implementations in which product 140/340 is not a smart device, product 140/340 may omit one or more of hardware processor 344, memory 346, and product software 348, while in implementations in which product 140/340 is not a connected product, product 140/340 may further omit transceiver 342. It is noted that in some implementations product 140/340 may be completely non-interactive, in which case product 140/340 may omit sensor(s) 360 and output unit 370 as well.

Although the present application refers to product software 348 as being stored in memory 346 for conceptual clarity, like system memory 106 of system 100/300, memory 346 may take the form of any computer-readable non-transitory storage medium, as described above. Like transceiver 114 of system 100/300, transceiver 342 of product 140/340 may be implemented as any suitable wireless communication unit. For example, transceiver 342 may include a 4G wireless transceiver and/or a 5G wireless transceiver. In addition, or alternatively, transceiver 342 may be configured for communications using one or more of Wi-Fi®, WiMAX®, Bluetooth®, BLE, ZigBee®, RFID, NFC, and 60 GHz wireless communications methods.

Sensor(s) 360 may include one or more microphones, one or more cameras, such as RGB still image cameras or video cameras, for example, one or more gyroscopes, and one or more accelerometers, for instance. As noted above, product 140/340 may be communicatively coupled to system 100/300 by local wireless communication link 362. As a result, in some implementations, product 140/340 may utilize data obtained from sensor(s) 360 to influence behavior of product 140/340. For example, if user 118 or performer 120 were to raise product 140/340 high in the air during generation of media content 122, that elevation of product 140/340 could be sensed by sensor(s) 360 and could trigger one or more sound effects or visual effects, such as lighting effects for example, by product 140/340. Hardware processor 344 may be the CPU for product 140/340, for example, in which role hardware processor 344 executes product software 348 to communicate with system 100/300 using transceiver 342, and controls sensor(s) 360 and output unit 370. It is noted that communication between product 140/340 and system 100/300 may be bidirectional.

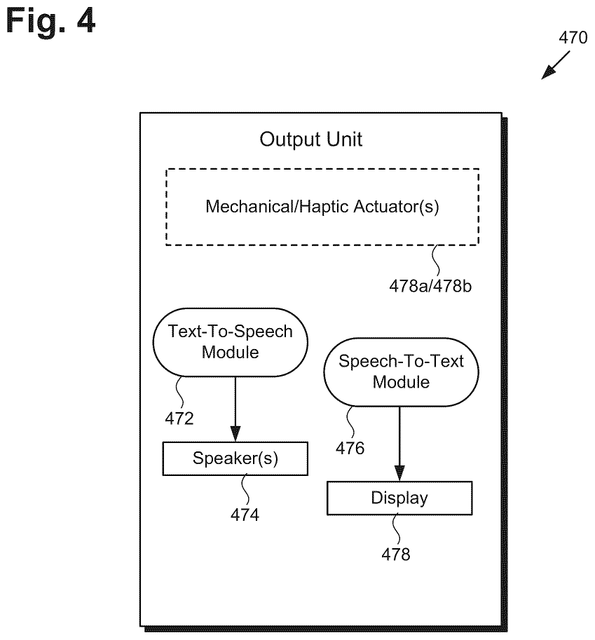

FIG. 4 shows a more detailed diagram of output unit 470 suitable for use as a component of product 140/340, in FIGS. 1 and 3, according to one implementation. As shown in FIG. 4, output unit 470 may include one or more of Text-To-Speech (TTS) module 472 in combination with one or more audio speakers 474 (hereinafter “speaker(s) 474”), and Speech-To-Text (STT) module 476 in combination with display 478. As further shown in FIG. 4, in some implementations, output unit 470 may include one or more mechanical actuators 478a (hereinafter “mechanical actuator(s) 478a”), one or more haptic actuators 478b (hereinafter “haptic actuator(s) 478b”), or a combination of mechanical actuator(s) 478a and haptic actuators(s) 478b.

It is further noted that, when included as a component or components of output unit 470, mechanical actuator(s) 478a may be used to produce facial expressions by product 140/340 in the form of a doll, companion animal toy, or robotic device, and/or to articulate one or more limbs or joints of product 140/340 in the form of a doll, companion animal toy, or robotic device. Output unit 470 corresponds in general to output unit 370 of product 140/340. Thus, output unit 470 may share any of the characteristics attributed to output unit 370 by the present disclosure, and vice versa.

It is noted that the specific features shown to be included in output unit 370/470 are merely exemplary, and in other implementations, output unit 370/470 may include more, or fewer, features than TTS module 472, speaker(s) 474. STT module 476, display 478, mechanical actuator(s) 478a, and haptic actuator(s) 478b. Moreover, in other implementations, output unit 370/470 may include a feature or features other than one or more of TTS module 472, speaker(s) 474. STT module 476, display 478, mechanical actuator(s) 478a, and haptic actuator(s) 478b. For example, in some implementations output unit 370/470 may include output features for producing lighting effects, as well as the sound effects produced by speaker(s) 474 and visual effects produced by display 478. It is further noted that display 478 of output unit 370/470 may be implemented as an LCD, LED display, OLED display, QD display, or any other suitable display screen that perform a physical transformation of signals to light.

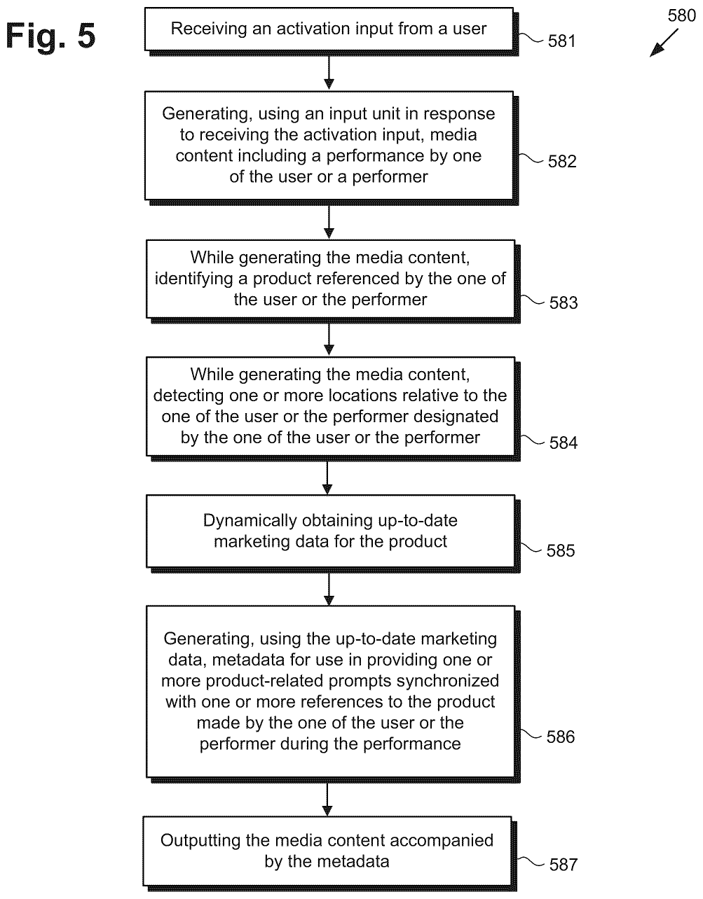

The functionality of software code 110 will be further described by reference to FIG. 5. FIG. 5 shows flowchart 580 presenting an exemplary method for use by a system to perform automated and dynamic provisioning of synchronized product-related prompts within media content, according to one implementation. With respect to the method outlined in FIG. 5, it is noted that certain details and features have been left out of flowchart 580 in order not to obscure the discussion of the inventive features in the present application. Referring to FIGS. 5 and 1 in combination, it is noted that the method outlined by flowchart 580 is described below by reference to an exemplary use case in which user 118 utilizes system 100 to generate media content 122 of himself/herself or performer 120 referencing product 140. Based on media content 122, the words and/or actions of user 118 or performer 120 in referencing product 140, automated communications from product 140, up-to-date marketing data 155, or any combination thereof, media content with prompt(s) metadata 154 is made available for consumption by one or more consumers 156. It is noted that media content with prompt(s) metadata 154 can be used to produce one or more product-related prompts enabling one or more consumers 156 to trigger an interaction associated with product 140 by responding to a product-related prompt while consuming media content with prompt(s) metadata 154. As noted above, examples of such triggered interactions may include learning more about the product, purchasing the product, and sharing the product with another user, to name a few.

Referring to FIG. 5, with further reference to FIGS. 1, 2, and 3, flowchart 580 may begin with receiving an activation input from user 118 (action 581). The activation input received in action 581 may take the form of a manual input to input device 132/232 by user 118, speech by user 118, or a contactless gesture by user 118. The activation input may be received in action 581 by software code 110, executed by hardware processor 104 of system 100/300, and may command use of a video camera of camera(s) 234c and microphone(s) 236 to generate media content 122 including a performance by one of user 118 promoting product 140/340 (i.e., a “selfie” video) or performer 120 promoting product 140/340.

Continuing to refer to FIGS. 1, 2, 3, and 5 in combination, flowchart 580 further includes generating, using input unit 130/230 in response to receiving the activation input in action 581, media content 122 including the performance by one of user 118 or performer 120 (action 582). As noted above, although system 100/300 is depicted as a smartphone or tablet computer of user 118 in FIGS. 1 and 3, that representation is provided merely by way of example. In other implementations, system 100/300 may take the form of any suitable mobile or stationary computing device or system that implements data processing capabilities sufficient to support connections to communication network 124 and product 140/340, and implement the functionality ascribed to system 100/300 herein. That is to say, in various implementations, system 100 may take the form of a TV or movie camera, a desktop computer, a laptop computer, or a wearable communication device such as a head-mounted or other type of body camera, to name a few examples. The generation of media content 122 including the performance by user 118 or performer 120 in action 582 may be performed by software code 110, executed by processing hardware 104 of system 100/300, and using video camera(s) 234c and microphone(s) 236 of input unit 130/230.

Continuing to refer to FIGS. 1, 2, 3, and 5 in combination, flowchart 580 further includes, while generating media content 122, identifying product 140/340 referenced by the one of user 118 or performer 122 during the performance (action 583). Identification of product 140/340 referenced by user 118 or performer 120, in action 583, may be performed by software code 110, executed by processing hardware 104 of system 100/300 in any of a variety of ways. It is noted that action 583 may further include identifying at what times during the performance depicted by the media content, product 140/340 is referenced by user 118 or performer 122, by being shown, held, gestured to, discussed, or otherwise invoked. For example, action 583 may include detecting timing information corresponding respectively to each reference to product 140/340 during the performance. Examples of such timing information may include one or more timestamps, video frame numbers, or any other information correlating references to product 140/340 with the playout of the performance.

By way of example, in some use cases, product 140/340 may be included in media content 122, by being held or gestured to by user 118 or performer 120. In use cases in which product 140/340 is configured for wireless communication, identifying product 140/340 may be performed in action 583 based on communication signal 364 received by system 100/300 from product 140/340 and self-identifying product 140/340. Alternatively, or in addition, in use cases in which product 140/340 is included in media content 122, product 140/340 may be identified in action 583 based on object recognition performed using OR sensor 234e of input unit 130/230, or based on gesture recognition of a predetermined identification gesture by user 118 or performer 120, wherein gesture recognition is performed using GR sensor 234d of input unit 130/230.

It is noted that gesture recognition of a predetermined identification gesture by user 118 or performer 120 may also be used to identify product 140/340 during recording of media content 122, even in use cases in which product 140/340 is not included in media content 122. i.e., is not shown or visible in media content 122. Moreover, in use cases in which product 140/340 is included in media content 122, as well as those in which product 140/340 is not included in media content 122, product 140/340 may be referenced in media content 122 by speech identifying or describing product 140/340 by the one of user 118 or performer 120 being video recorded promoting product 140/340.

Continuing to refer to FIGS. 1, 2, 3, and 5 in combination, in some implementations, the method outlined by flowchart 580 may further include, while generating media content 122, detecting one or more locations relative to user 118 or performer 120 promoting product 140/340 that is/are designated by that user or performer for placement of a product-related prompt (action 584). Detection of the one or more locations designated by user 118 or performer 120, in action 584, may be performed by software code 110, executed by processing hardware 104 of system 100/300 in a number of ways.

By way of example, in some use cases, as noted above, product 140/340 may be included in media content 122, by being held or gestured to by user 118 or performer 120. In some of those use cases, the one or more locations relative to user 118 or the performer 120 that is/are designated by user 118 or performer 120, may be detected based on how the product 140/340 is held by user 118 or performer 120 during the performance by user 118 or performer 120. For instance, when user 118 or performer 120 faces the video camera used to generate media content 122, holds product 140/340 in his/her right hand, and raises his/her right hand, system 100/300 may detect the location being designated by user 118 or performer 120 for placement of a product-related prompt as the upper left quadrant of the video frame or frames in which product 140/340 is shown being held thus. Analogously, when user 118 or performer 120 faces the video camera used to generate media content 122, holds product 140/340 in his/her left hand, and lowers that his/her left hand, system 100/300 may detect the location being designated by user 118 or performer 120 for placement of the product-related prompt as the lower left quadrant of the video frame or frames in which product 140/340 is shown being held in that way, and so forth.

Alternatively, or in addition, in use cases in which product 140/340 is included in media content 122, as well as those use cases in which product 140/340 is not included in media content 122, the one or more locations relative to the user 118 or performer 120 may be detected based on a gesture by user 118 or performer 120, which may be a predetermined locational gesture or a spontaneous gesture, or based on speech by user 118 or performer 120 identifying one or more locations for placement of a product-related prompt.

As another alternative, or in addition, in use cases in which product 140/340 is included in media content 122, as well as those use cases in which product 140/340 is not included in media content 122, the one or more locations relative to the user 118 or performer 120 may be detected in action 584 based on a or a three-dimensional (3D) hand position of user 118 or performer 120 identified using lidar detector 234a of input unit 130/230.

In use cases in which product 140/340 is included in media content 122 and is also configured for wireless communication, the one or more locations relative to the user 118 or performer 120 may be detected in action 584 based on communication signal 364 received from product 140/340. For example, as noted above, transceiver 114 of system 100/300 may include an array of antennas for one or more of the communication modes supported by transceiver 114. Thus, in implementations in which product 140/340 transmits communication signal 364 using Bluetooth® or BLE, for example, system 100/300 may utilize an array of Bluetooth® or BLE antennas included in transceiver 114 to detect the one or more locations relative to user 118 or performer 120.

It is noted that action 584 described above is optional, and in some implementations may be omitted from the method outlined in FIG. 5. In those implementations in which action 584 is omitted, flowchart 580 may transition directly from action 583 to action 585 described below.

Continuing to refer to FIGS. 1, 2, 3, and 5 in combination, flowchart 580 further includes dynamically obtaining up-to-date marketing data 155 for product 140/340 (action 585). Up-to-date marketing data 144 of product 140/340 may include current pricing and available discounts applicable to purchase of product 140/340. In addition, in use cases in which product 140/340 has been, or is about to be, replaced by a newer or updated version of product 140/340, up-to-date marketing data 155 may identify the updated product, its anticipated availability data, as well as pricing and applicable discounts. The product-related prompt or prompts included in up-to-date marketing data 155 may include one or more visual overlays in the form of graphics, text, AR visual effects, one or more audio prompts such as voice-over instructions, or any combination thereof.

In some implementations, up-to-date marketing data 155 may be obtained dynamically, in action 585, from product marketing database 150 or product source 128, by software code 110, executed by processing hardware 104 of system 100/300, and using communication network 124 and network communication links 126, while media content 122 is being generated. However, in other implementations, media content 122 and the data generated in action 583, and optionally action 584, may be transmitted to CDN 152. In those implementations, action 585 may be performed by CDN 152.

It is noted that one significant advantage of automating actions 583, 584, and 585, or action 583 followed by action 585, is that the cumbersome and static predetermination of a particular product and its associated details in the conventional art can be avoided entirely, and instead, product 140/340 can be identified and up-to-data marketing data 155 can be obtained, on-the-fly, in real-time, during the generation of media content 122. Thus, for example, user 118 or performer 120 may make a change to the particular product or products being promoted shown, discussed, or otherwise referenced in using media content 122, at the time media content 122 is generated, and still obtain relevant and accurate up-to-date marketing data 155 for product 140/340.

It is further noted that although action 585 is depicted in FIG. 5 as following action 584, that representation is merely provided by way of example. In various implementations in which the method outlined by flowchart 580 includes action 585, action 585 may precede action 584, may follow action 584, or may be performed in parallel with, i.e., contemporaneously with, action 584.

Continuing to refer to FIGS. 1, 2, 3, and 5 in combination, flowchart 580 further includes, generating, using the up-to-date marketing data obtained in action 585, metadata for use in providing one or more product-related prompts synchronized with the references to the product made by the one of the user or the performer during the performance (action 586). The metadata generated in action 586 may include timing information, such as one or more timestamps, frame numbers, or the like, corresponding respectively to each instance at which product 140/340 is shown, or invoked by speech or gesture, during the performance.

It is noted that in implementations in which the method outlined by flowchart 580 includes action 584 described above, action 586 may be based on the one or more locations relative to user 118 or performer 120 detected in action 584. It is further noted that when the one or more locations detected in action 584 is/are used in synchronizing one or more product-related prompts with the references to product 140/340 during the performance, the one or more locations detected in action 584 do not necessarily need to translate one-to-one to the positions at which the product-related prompts are displayed to consumers, although in the typical uses cases those positions would likely correspond well.

In some implementations, action 586 may be performed by software code 110, executed by processing hardware 104 of system 100/300. However, in other implementations, media content 122 and the data generated in action 583, and optionally action 584, may be transmitted to CDN 152. In those implementations, action 586 may be performed by CDN 152. For example, the time stamp determination or determinations performed in action 586 may be based on the video frame or frames of media content 122 in which product 140/340 appears or is invoked.

As noted above, the one or more product-related prompts may include one or more visual overlays in the form of graphics, text. AR visual effects, one or more audio prompts such as voice-over instructions, or any combination thereof. That/those one or more product-related prompts may identify product 140/340, as well as provide pricing information for purchase of product 140/340. Moreover, in some implementations, the one or more product-related prompts may include an embedded universal resource identifier (URI), such as a universal resource locator (URL), enabling a viewer of media content with prompt(s) metadata 154 to trigger an interaction with product 140/340 while viewing media content with prompt(s) metadata 154.

In some implementations, the method outlined by flowchart 580 may conclude with action 586 described above. However, in other implementations, as shown by FIG. 5, flowchart 580 may further include outputting media content with prompt(s) metadata 154 (action 587). For example, in some implementations outputting media content with prompt(s) metadata may include one or more of broadcasting, streaming, or live-streaming media content with prompt(s) metadata 154 to one or more consumers 156. In some use cases, media content with prompt(s) metadata 154 may be transmitted to multiple viewers, such as tens, hundreds, thousands, or millions of viewers for example, via communication network 124 and CDN 152, or via a peer-to-peer network as discussed below. In some implementations, action 587 may be performed by software code 110, executed by processing hardware 104 of system 100/300. However, in other implementations, media content 122 and the data generated in action 583, and optionally action 584, may be transmitted to CDN 152. In those implementations, action 587 may be performed by CDN 152.

Alternatively, in some use cases, user 118 and one or more consumers 156 may be engaged in a group watch session. In those use cases, system 100/300 may be communicatively coupled to one or both of user devices 158a and 158b via a peer-to-peer network enabling user 118 to transmit media content with prompt(s) metadata 154 to one or more of consumers 156a and 156b while user 118 and consumers 156a and 156b are collectively but remotely consuming the same media content contemporaneously. It is noted that in any of the implementations in which media content with prompt(s) metadata 154 is distributed to one or more consumers 156, e.g., by being streamed broadcast, streamed, live-streamed, or transmitted peer-to-peer, the one or more product-related prompts media content with prompt(s) metadata 154 enable any of one or more consumers 156 to trigger an interaction associated with product 140/340 by responding to a product-related prompt.

In some use cases, as shown in FIG. 1, one or more of one or more consumers 156, such as consumer 156b for example, may own possessed product 168, which may be a connected device configured for wireless communication with user device 158b or system 100/300, such as an IOT device, for example. In those implementations, media content with prompt(s) metadata 154 may cause possessed device 168 to interact with consumer 156b so as to encourage purchase of product 140/340. For example, where product 140/340 is a toy replica of sidekick action superhero “B” having the role of wingman to action superhero “A” in a movie or movie franchise, and possessed product 168 is a connected toy replica of action superhero “A.” playout of media content with prompt(s) metadata 154 promoting the superhero “B” toy by user device 158b may cause possessed product 168 to react, such as by moving, emitting light, or generating audio in the form of music or speech. For instance the appearance of product 140/340 in media content with prompt(s) metadata 154 played out by user device 158b may cause possessed device 168 to generate speech stating: “Hey, that is my wingman.”

Thus, the present application discloses systems and methods for performing automated and dynamic provisioning of synchronized product-related prompts within media content that address and overcome the deficiencies in the conventional art. With respect to the method outlined by flowchart 580, it is emphasized that actions 581 through 584 and 586, or actions 581 through 584 and action 586 and 587, or actions 581 through 586, or actions 581 through 587, may be performed in an automated process from which human involvement may be omitted. The present solution advances the state-of-the-art by enabling product-related prompts to be automatically updated dynamically if product-related metadata changes, such as the name or price of a product, for example. In addition, the present solution improves over conventional approaches by allowing the data for generating product-related prompts to be configured automatically rather than manually. Moreover, in some implementations, product-related prompts can be generated and appended to media content automatically, not only by content creators, but in a peer-to-peer process by viewers of the video, engaging in a group watch session of the video for example.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

What is claimed is:

1. A system comprising:
a hardware processor;
an input unit; and
a system memory storing a software code;
the hardware processor configured to execute the software code to:
receive an activation input from a user;
generate, using the input unit in response to receiving the activation input, media content including a performance by one of the user or a performer;
identify, while generating the media content, a product referenced by the one of the user or the performer;
dynamically obtain up-to-date marketing data for the product;
generate, using the up-to-date marketing data, metadata for use in providing one or more product-related prompts synchronized with one or more references to the product made by the one of the user or the performer during the performance; and
output the media content accompanied by the metadata.

2. The system of claim 1, wherein the hardware processor is further configured to:
at least one of broadcast, stream, or live-stream the media content to a plurality of consumers;
wherein the one or more product-related prompts enable any of the plurality of consumers to trigger an interaction associated with the product while consuming the media content.

3. The system of claim 1, wherein the system comprises one of a smartphone or a tablet computer of the user.

4. The system of claim 1, wherein the one or more product-related prompts comprise at least one of a visual overlay or an audio prompt.

5. The system of claim 1, wherein identifying the product is based on speech identifying the product by the one of the user or the performer.

6. The system of claim 1, wherein the hardware processor is further configured to execute the software code to:
detect one or more locations relative to the one of the user or the performer designated by the one of the user or the performer during the performance;
wherein synchronizing the product-related prompt with the one or references to the product is based on the one or more locations relative to the one of the user or the performer.

7. The system of claim 6, wherein the one or more locations relative to the one of the user or the performer is/are detected based on at least one of (i) a gesture by the one of the user or the performer, (ii) a three-dimensional (3D) hand position of the one of the user or the performer, or (iii) speech by the one of the user or the performer.

8. The system of claim 6, wherein the one of the user or the performer holds the product during the performance, and wherein the one or more locations relative to the one of the user or the performer, designated by the one of the user or the performer, is detected based on how the product is held by the one of the user or the performer.

9. The system of claim 8, wherein identifying the product comprises performing object recognition of the product.

10. The system of claim 8, wherein the product is configured for wireless communication, and wherein identifying the product is based on a communication signal received from the product.

11. A method for use by a system including a hardware processor, an input unit, and a system memory storing a software code, the method comprising:
receiving, by the software code executed by the hardware processor, an activation input from a user;
generating, in response to receiving the activation input, by the software code executed by the hardware processor and using the input unit, media content including a performance by one of the user or a performer;
identifying, by the software code executed by the hardware processor while generating the media content, a
product referenced by the one of the user or the performer;
dynamically obtaining, by the software code executed by the hardware processor, up-to-date marketing data for the product;
generating, by the software code executed by the hardware processor and using the up-to-date marketing data, metadata for use in providing one or more product-related prompts synchronized with one or more references to the product made by the one of the user or the performer during the performance; and
outputting, by the software code executed by the hardware processor, the media content accompanied by the metadata.

12. The method of claim 11, further comprising:
at least one of broadcasting, streaming, or live-streaming the media content, by the software code executed by the hardware processor, to a plurality of consumers;
wherein the one or more product-related prompts enable any of the plurality of consumers to trigger an interaction associated with the product while consuming the media content.

13. The method of claim 11, wherein the system comprises one of a smartphone or a tablet computer of the user.

14. The method of claim 11, wherein the one or more product-related prompts comprise at least one of a visual overlay or an audio prompt.

15. The method of claim 11, wherein identifying the product is based on speech identifying the product by the one of the user or the performer.

16. The method of claim 11, further comprising:
detecting, by the software code executed by the hardware processor, one or more locations relative to the one of the user or the performer designated by the one of the user or the performer during the performance;
wherein synchronizing the product-related prompt with the one or references to the product is based on the one or more locations relative to the one of the user or the performer.

17. The method of claim 16, wherein the one or more locations relative to the one of the user or the performer is/are detected based on at least one of (i) a gesture by the one of the user or the performer, (ii) a three-dimensional (3D) hand position of the one of the user or the performer, or (iii) speech by the one of the user or the performer.

18. The method of claim 16, wherein the one of the user or the performer holds the product during the performance, and wherein the one or more locations relative to the one of the user or the performer, designated by the one of the user or the performer, is detected based on how the product is held by the one of the user or the performer.

19. The method of claim 18, wherein identifying the product comprises performing object recognition of the product.

20. The method of claim 18, wherein the product is configured for wireless communication, and wherein identifying the product is based on a communication signal received from the product.
